(19) United States
(12) Patent Application Publication
(10) Pub. No.: US 2018/0018382 A1
(43) Pub. Date: Jan. 18, 2018

(54) SYSTEM FOR DEFINING CLUSTERS FOR A SET OF OBJECTS

(71) Applicant: SAP SE, Walldorf (DE)

(72) Inventors: Konstantin Skodinis, Heidelberg (DE); Matthias Schmitt, Speyer (DE)

(21) Appl. No.: 15/208,250

(22) Filed: Jul. 12, 2016

(51) Int. Cl. G06F 17/30

(52) U.S. Cl. CPC G06F 17/30598; G06F 17/30607

(57) ABSTRACT

A set of objects is defined from a plurality of objects. The objects are defined with a common structure including properties. The plurality of objects is to be clustered into clusters. A clustering criterion for determining the clusters is defined. The clusters are non-intersecting sets of objects from the set of objects. Object distance between a first object and a second object from the set of objects is computed. The computation of the object distance is based on computation of distances between property values defined for properties from the structure of the objects from the set. When the first object is a part of the cluster, the second objects is added to the cluster when the object distance complies with the clustering criterion. The clusters are determined in a number of iterations based on evaluations of the distances between objects from subsequently determined subsets of objects from the plurality.

### FIELD

The field generally relates to data processing and data clustering systems.

### BACKGROUND

Data objects may be used and defined in different contexts. For example, objects may be created for defining customers or suppliers of a particular company, products or materials, articles of any type, employees, custom-developed object types, etc. Consolidating data associated with the data objects may require a lot of resources. Clustering is associated with grouping of data objects. Clustering of data objects may be utilized when dealing with data in different fields including biology, physics, chemistry, computer science, marketing, analytics, data classification, and master data management. Clustering analysis is performed over a huge number of dimensions and data. Software applications and systems maintain data for enormous amount of objects defined in different formats, structures, etc. Clustering of data objects may provide insight into disparity of the data.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an exemplary projection of a set of objects on a coordinate system for determining a plurality of clusters for the set of objects, according to one embodiment.

FIG. 2 is a block diagram illustrating an exemplary projection of four objects on a coordinate system for determining clusters based on computed distances between properties of the objects, according to one embodiment.

FIG. 3 is a flow diagram illustrating a process for determining clusters for a plurality of objects, according to one embodiment.

FIGS. 4A and 4B are block diagrams illustrating systems for determining a plurality of clusters for a set of objects, according to some embodiments.

FIG. 5 is a flow diagram illustrating a process for determining a plurality of clusters for a set of objects, according to one embodiment.

FIG. 6 is a flow diagram illustrating a process for determining a plurality of clusters within a set of objects, according to one embodiment.

FIG. 7 is a block diagram illustrating an exemplary projection of a set of objects on a coordinate system for determining a plurality of clusters based on circles definitions to optimize the clustering process, according to one embodiment.

FIG. 8 is a block diagram illustrating an embodiment of a computing environment in which the techniques described for determining a plurality of clusters within the set of objects can be implemented.

### DETAILED DESCRIPTION

Embodiments of techniques for system for defining clusters for a set of objects are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Clustering a big amount of data into groups, called clusters, may be performed through allocating data objects to clusters. The allocation may be based on determined similarities, complying with clustering criteria, or other defined differentiator for clustering. For example, a cluster is a collection of objects which are “similar” to each other and which are “dissimilar” to the objects belonging to other clusters. The similarity or dissimilarity can be expressed by some criteria depending on the requestor for the clustering.

A set of objects may be defined to represent a set of items or entities. The items or entities may be manufacturing products, such as cars. The items or entities may be objects defining customers, suppliers, organizations, etc. The set of data objects may be of a common type, defined with a predefined structure. The objects from the set may be defined with a number of properties that characterize the entities that they represent. The set of objects may be presented as a set of points in an n-dimensional space. The number of the axes may correspond to the number of properties defined for describing the objects. For example an object may be a car with axes color, weight, and year. A set of objects may be the cars of a company.

A distance measure between single components of data may be computed for a pair of data objects. The distance measure is defined between two objects of the set and may be presented as a real number. A computed distance value is a non-negative real number. The distance measure may be defined to satisfy one or more conditions. For example, the distance measure may satisfy a condition defining that the distance between an object and itself is equal to zero. A second exemplary condition that may be satisfied for the distance measure is that the distance is symmetric. In the second exemplary condition, it may be defined that when computing distances for objects A and B, the distance between A and B, and B and A is the same. Further, the distance measure may also be defined to satisfy a “triangle inequality” condition. The “triangle inequality” condition may state that if we have three objects—A, B, and C, then the sum of distances between A and B and B and C, is larger than the distance between A and C. For example, if the objects of the set are presented in a Euclidean space, then the distance is a metric, which satisfies the “triangle inequality” condition. If the objects of the set are presented as points in a Cartesian space, the distance may be defined as a combination of distance measures referring to Cartesian coordinates. If the distance measure definition does not satisfy the “triangle inequality”, one or more techniques may be applied to obtain a distance measure, satisfying the “triangle inequality”.

For example, a set of objects is defined for a set of cars. The set of cars are projected on a coordinate system. The coordinates for the set of cars are defined to include color, year of production, and weight. For a given coordinate, the distance between two cars with respect to that coordinate, is defined to be zero, if their coordinate values are the same. If the coordinate values are not the same, then the distance is defined to be equal to one. The distance between the cars is defined by the sum of all coordinate distance values. Such a distance measure is a distance that satisfies the “triangle inequality” condition. The calculation between two objects may be an operation, which consumes a lot of resources. The calculation may be performed according to a predefined formula for computation.

The distance measure may be associated with a definition of clustering criteria to be applied over a set of data objects for defining clusters. The distance between two objects expresses their “similarity” or “dissimilarity”. The less the distance between two objects, the bigger the similarity. Analogously, the bigger the distance, the bigger the dissimilarity. The similarity/dissimilarity depends on the given distance measure and a defined threshold distance value for the clustering. The threshold distance value may be defined with the clustering criteria. For example, two objects from the set of objects may be classified as similar and included in one cluster, if the computed distance between them is less or equal to a given threshold distance value.

In one embodiment, when a set of objects, a distance measure, and a threshold distance value “r” are defined, then two objects from the set may be called neighbors, if the distance between them is at most “r”. The neighborhood of an object is the set of all neighbors for that object. The neighborhood of an object can be seen as a sphere with a center, corresponding to the object and a radius equal to “r”. The sphere may be defined to contain neighbors of this object. A cluster may be defined as a subset of a neighborhood for objects from the set. An element of a cluster whose distance to other elements of the cluster is equal or less than the given threshold distance value is called a representative for the cluster. For example, the cluster can be defined as a sphere, with a given object as the center and radius equal to “r”. The center of the cluster is the representative of the cluster. A cluster contains objects, which are “similar” to each other. Comparing objects in order to determine distances among them is an expensive operation. Therefore, a clustering algorithm may be defined to minimize the number of the performed comparisons of distances between objects within a set of objects.

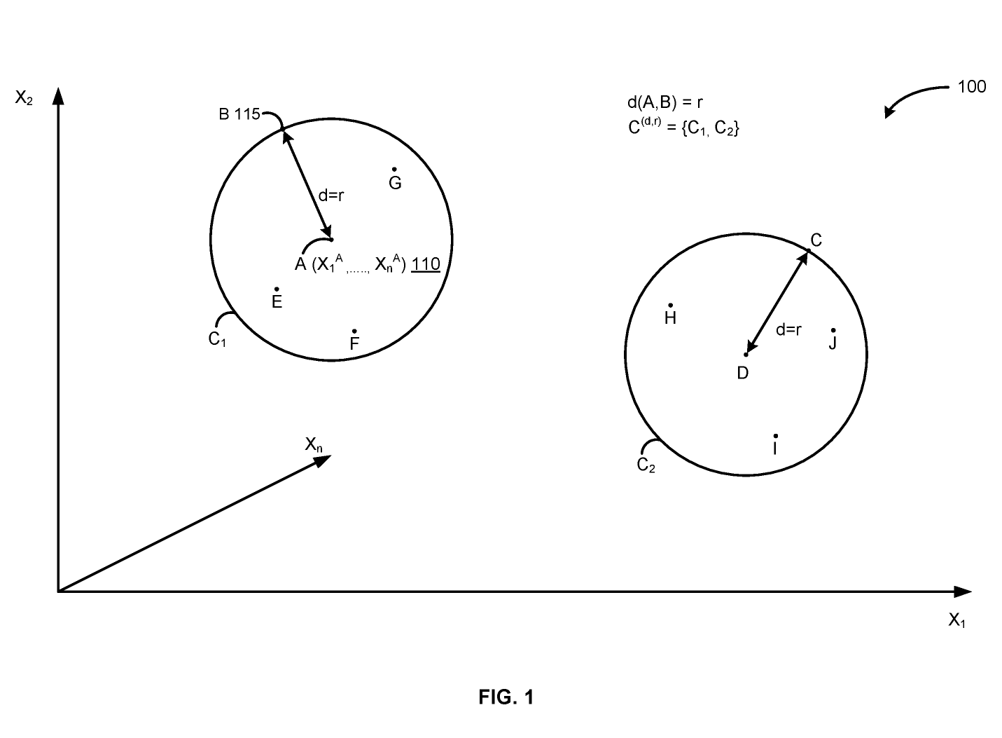

FIG. 1 is a block diagram illustrating an exemplary projection 100 of a set of objects on a coordinate system for determining a plurality of clusters for the set of objects, according to one embodiment. The coordinate system may be a Cartesian coordinate system and may be n-dimensional, having n number of axes—X₁, X₂, until Xₙ. The number of the axes may correspond to the number of properties defined for describing the objects. The set of objects are projected on the coordinate system—points A, B, C, D, E, F, G, H, I, and J. The set of objects are defined to have the same structure including a number of properties. The set of points corresponds to the set of objects and are projected on the coordinate system based on the values defined for different properties of the objects. Point A 110 is defined with point coordinates represented as an n-tuple (X₁^{A}, X₂^{A}, . . . , Xₙ^{A}). X₁^{A}, X₂^{A}, to Xₙ^{A} are property values that describe object X, which is projected as point A. The object X may be a car, having a red color, with 1000 kg weight, produced in year 2015, and other characteristics. The color, weight, and year of production, etc. correspond to the defined axes X₁, X₂, until Xₙ.

Clustering criteria may define the manner of determining the projected points A, B, C, etc., and computing distances between the projected points. The clustering criteria may also include a rule for determining whether a subset of points from the set of projected points corresponds to objects, which may be grouped in one cluster. Such a rule may define a distance threshold value that may be compared with computed distances between the points. For example, the distance threshold value defined for clustering the projected objects may be defined to be an “r” value, where “r” is a real number. The “r” value may be a non-negative real number.

Two clusters are defined for all of the point—C (d, r)={C₁, C₂}. Points A, E, F, B, G are clustered in cluster C₁, as the distance values between each of the points A, E, F, B, G are determined to be equal or less than the distance threshold value “r”. Points H, D, C, I, and J are clustered in cluster C₂, as the distance values between each of the points H, D, C, I, and J are determined to be equal or less than the distance threshold value “r”. The distance between points A 110 and B 115 is exactly “r”. The distance between point A and B may be computed as an accumulative value based on distances between coordinates values for the points A and B. The distance between point A and all of the other points from the cluster C₁ is equal or less then the value “r”, therefore A may be defined as a representative for the cluster C₁. The cluster C₁ may be interpreted as a spherical object with a radius equal to the value “r”. Point A, as a representative for cluster C₁, is a central point for the spherical object. Point B is projected on the outer bound of the spherical object, as the distance between the central point A and point B is a radius for the defined spherical object, which is exactly the distance threshold value “r”.

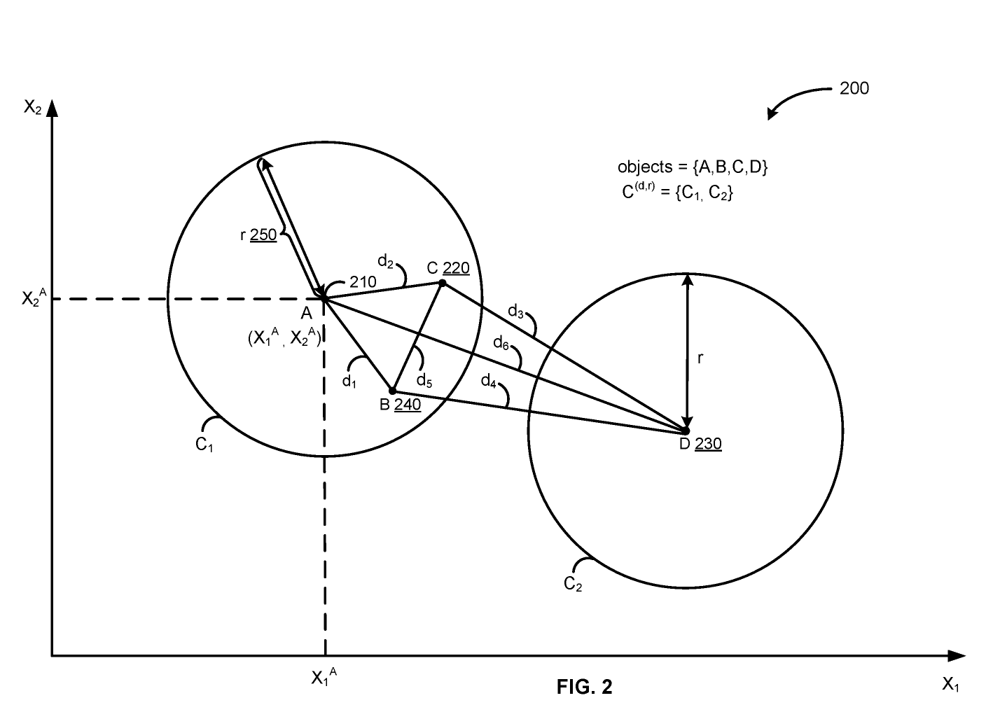

FIG. 2 is a block diagram illustrating an exemplary projection 200 of four objects on a coordinate system for determining clusters based on computed distances between properties of the objects, according to one embodiment. The coordinate system is a two-dimensional coordinate system, which has two axes X₁ and X₂. The two axes correspond to two properties defined in the structure of the objects. The four objects are projected on the coordinate system as points A 210, B 240, C 220, and D 230. For example, point A 210 has coordinates (X₁^{A}, X₂^{A}). The objects projected by point A, B, C, D are clustered according to clustering criteria, which defines a distance threshold value “r”. The threshold value “r” is a real number.

In the exemplary projection 200, distances between the points A, B, C, D are computed. Then, the distances are evaluated in relation to the defined clustering criteria, including the distance threshold value “r” as a reference number. Table 1 defines an exemplary computation of distances between objects from the set. The defined values in Table 1—d₁, d₂, to d₆, are real number values. The computed distances between the points presented in Table 1 below may be used for comparisons with the value “r”. The computation of the distances is performed based on computing distances between the property values defined for the two properties for the four objects.

TABLE 1

| | A | B | C | D |
|---|---|---|---|---|
| A | 0 | d₁ | d₂ | d₆ |
| B | — | 0 | d₅ | d₄ |
| C | — | — | 0 | d₃ |
| D | — | — | — | 0 |

The computed distances may be evaluated. The evaluation of the distances includes a comparison of the distances with the defined distance threshold value “r”. The distances d₁, d₂, d₃, to d₆ are compared with “r”. The computed distances may be mapped to a Boolean value to reflect the neighborhood relationship between the objects and to assist in determining clusters. When a computed distance value between two points is equal or less than “r”, then the relationship between these two points may be evaluated and mapped to 1. When a computed distance value between two points is greater than “r”, then the relationship between these two points may be mapped to 0. For example, the distance d₁ may be smaller than “r”, then d₁ may be mapped to a value of 1. Further, all of the distances may be mapped to either 0 or 1 based on the comparison. Table 2 includes an exemplary evaluated distances between the four objects. The mapped values are associated to relationships between objects and may provide insight into the similarities between the objects based on proximity of the distance between the objects. For example, if the distance value is mapped to 1, then the distance between the two points is very close and the two points may be grouped in one cluster. Further additional interpretations may be performed over all of the mapped values of the distances to determine the clusters for the four objects.

TABLE 2

| | A | B | C | D |
|---|---|---|---|---|
| A | 1 | 1 | 1 | 0 |
| B | — | 1 | 1 | 0 |
| C | — | — | 1 | 0 |
| D | — | — | — | 1 |

In one embodiment, based on the defined mapped values in Table 2, a count of number of neighbors for the objects may be computed as a sum of evaluated values corresponding to relations between the given object and the rest of the objects from the set. A neighbor to a selected objects may be defined as another object, whose distance to the selected object is equal or less the distance threshold value “r”. Therefore, with respect to the presented Table 2, the neighbors of a given object presented in a particular row, are those objects, which are mapped to a value of 1. For example, for the first row, which is associated with point A, the count of neighbors is 2, as the relations between A and B, and A and D are mapped to the value “1” (a real number) (Table 3, second row of the table, third column and fifth column, where A and B; and A and D columns are crossing). Table 3 provides the counted numbers of neighbors.

TABLE 3

| | | | | | Count of |
|---|---|---|---|---|---|
| | A | B | C | D | neighbors |
| A | 1 | 1 | 0 | 1 | 3 |
| B | — | 1 | 0 | 1 | 2 |
| C | — | — | 1 | 0 | 1 |
| D | — | — | — | 1 | 1 |

Based on the computed neighbors for the objects, an object with the highest number of neighbors is selected. In the example in Table 3, the selected objects corresponds to point A. Point A, together with other point which correspond to neighbors for point A are grouped in one cluster—C₁. The distance between objects from cluster C₁ is less than the value “r”. A radius 250 for a circle, which graphically defines cluster C₁, is equal to the threshold value “r”. The circle may be drawn to include points A, B, and C. Further the circle may be with a center—point A. Cluster C₁ comprises objects projected to points A, B, and D. Then, Table 3 may be reevaluated to exclude the points that are already allocated to cluster C₁. Table 3 may be updated based on techniques, for example a doubly linked list structure can be used. The excluded points are A, B and C. There is only one point left out in the table—point D. Then point D is grouped in a second cluster—C₂. Therefore, as a result of the clustering analysis, two clusters are defined for the four objects. The definition of the clusters may be stored in a data structure, such as a linked list of lists, where an element of the list represents a cluster, and a cluster is a list of the cluster' objects.

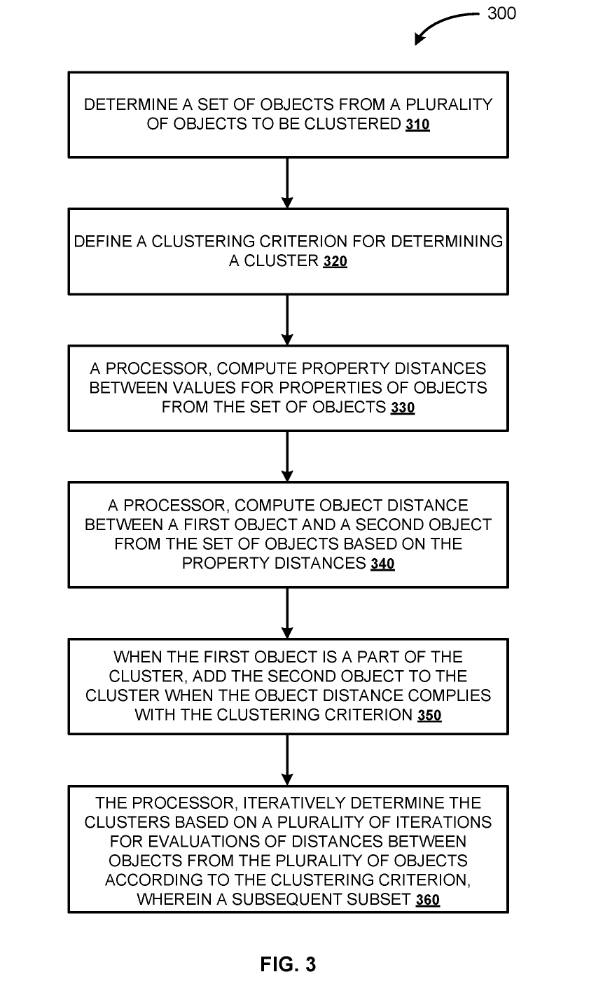

FIG. 3 is a flow diagram illustrating a process 300 for determining clusters for a plurality of objects, according to one embodiment. At 310, a set of objects from the plurality of objects is determined to be included into clusters. The plurality of objects may be of a common type and defined with a structure, which includes properties of the objects. The set of objects may be such as the objects discussed above in relation to FIG. 1 and FIG. 2. The set of objects from the plurality may be determined to include a cluster. The set of objects may be a subset of the plurality of objects that is defined based on criteria for dividing the plurality of objects into subsets. For example, the set of objects may be determined based on a common value defined for a property of the objects from the set. The objects may be ordered according to property values for one of the properties. Based on the order, a subset of objects may be determined to include objects that have equal property values. At 320, a clustering criterion for determining a cluster is defined. The clusters are non-intersecting sets of objects that are defined based on the initially provided plurality of objects for clustering. The clustering criterion may correspond to the discussed clustering criteria in FIG. 1 and FIG. 2. The clustering criterion may define a distance threshold value for evaluating computed distances between objects from the set.

At 330, a processor computes distances between values for properties of objects from the set of objects. The distances between properties values may be computed based on a predefined formula for determination of a distance measure. As the objects may be defined with a common structure, the properties values defined for objects from the set are of a matching number, and distances are computed one by one. At 340, object distance between a first object and a second object from the set of objects is computed based on the property distances. The object distance is computed as an aggregation measure of the distances between the properties values. At 350, when the first object is a part of the cluster, then the second object is added to the cluster when the object distance complies with the clustering criterion. At 360, the processor iteratively determines the clusters for the plurality of objects. The determination of the clusters is based on a plurality of iterations for evaluation of distances between objects from the plurality. The evaluation of the distances is performed according to the clustering criterion. The iterations that are performed may be associated with subsets of objects from the plurality of objects. A subsequent subset of objects is evaluated at a subsequent set, and the subsequent subset may be defined based on a previously evaluated subset associated with a previous iteration. For example, a first iteration of the process of determining the clusters is associated with the determined set of objects from the plurality of objects.

In some embodiments, the distances between all of the objects from the plurality of objects may be computed. For example, when the distance measure is defined in such a way that it does not satisfy the “triangle inequality”, then all of the distances between the objects are computed. In other embodiments, an object from the plurality may be selected, and distances between the selected object and the rest of the objects are computed. In such manner, the number of computed distances is smaller compared to the computed distances between all of the objects from the set. Based on the ordered list of objects, a small subset of the objects is taken for evaluations through the iterations of determining the clusters. Through determining a smaller subset of objects, a smaller number of computations and evaluations of distances between the objects may be performed. Thus, computing and hardware resources may be utilized in an optimized manner.

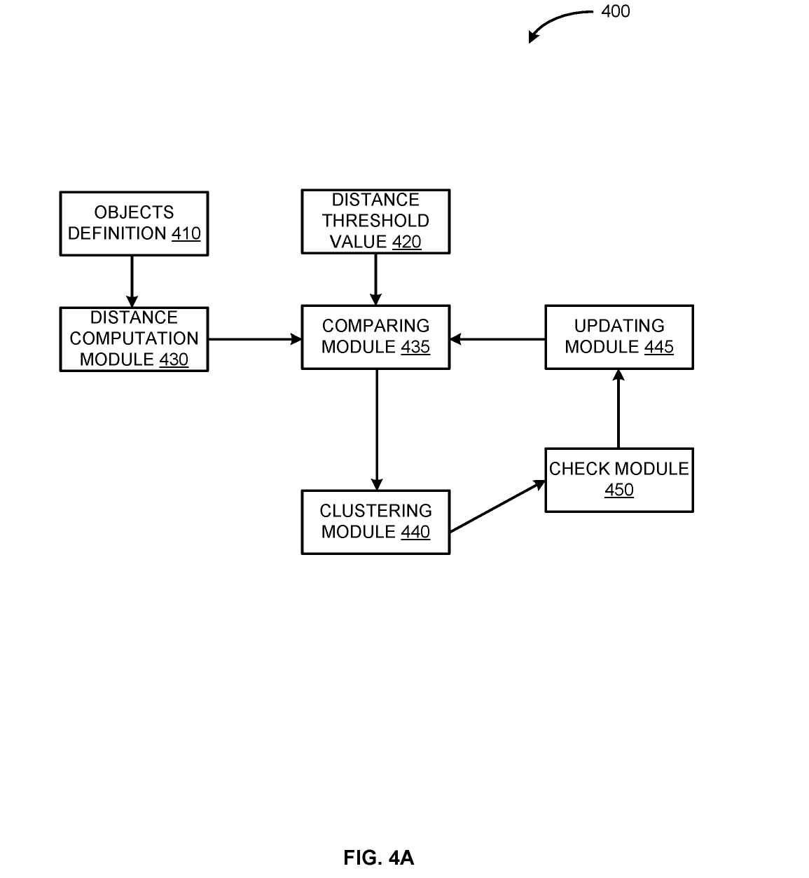

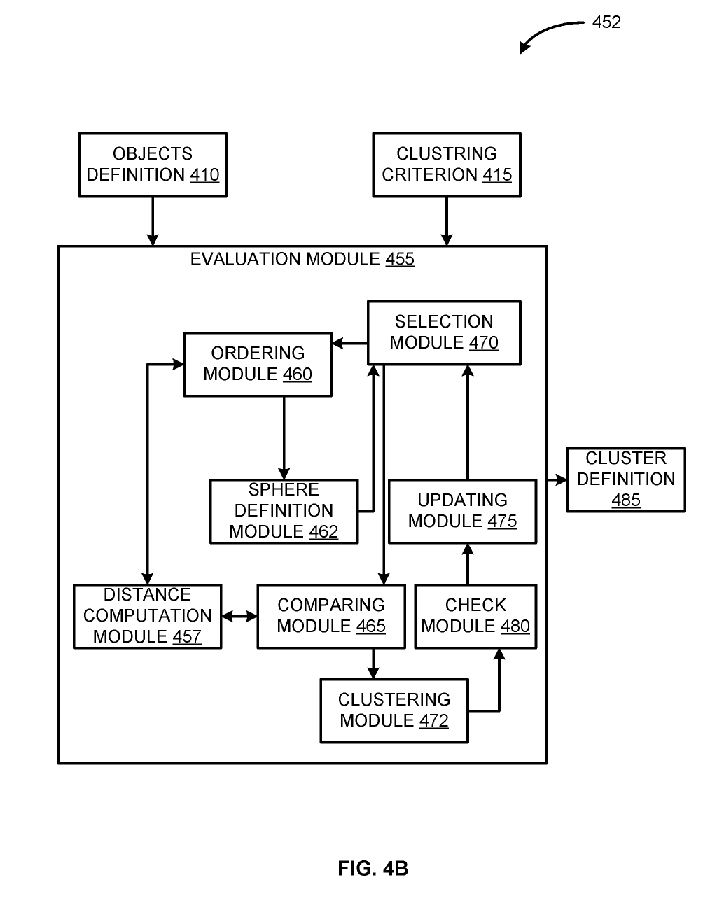

FIG. 4A is a block diagram illustrating a system 400 for determining a plurality of clusters for a set of objects, according to one embodiment. Determining the clusters for the set of objects as illustrated on system 400 may be performed when a defined distance measure satisfies a set of conditions. Determining the clusters for the set of objects as illustrated on system 400 may be performed when the distances measure does not satisfy a “triangle inequality” condition.

The set of objects is defined in an objects definition 410. The clustering is performed according to a distance threshold value 420. The distances between the defined objects in the object definition 410 may be computed by a distance computation module 430. The distance computation module 430 receives the distance threshold value 420 and provides computed distances to a comparing module 435. The comparing module 435 includes an implementation logic to determine a new cluster. Based on the implemented logic, a table containing neighborhood relationships between the objects defined in the object definition 410 may be generated. The definition of the neighboring relations in the table is performed according to the distance threshold value 420. The table may correspond to Table 3 discussed in relation to FIG. 2. The comparing module 435 may determine an object with highest number of neighbors. The object with the highest number of neighbors may be defined as a representative object for a first determined cluster. The first cluster includes the representative object and the neighbors of the representative objects. The determined first cluster may be communicated to the clustering module 440. The clustering module 440 records the definition of the first cluster. The clustering module 440 communicates with a check module 450 to determine whether the set of objects is completely evaluated and whether all of the objects are allocated to clusters. When the check module 450 determines that the set of objects is not completely evaluated, then the check module 450 invokes an updating module 445. The updating module 445 evaluates the set of objects to determine a subset of the set that includes objects that are not allocated to already defined clusters. The objects that are not allocated to clusters may be excluded from the generated table by the comparing module 435. The updating module 445 communicates with the comparing module 435 to provide the determined subset. Based on the received information from the updating module 445, the comparing module redefines the generated table. The redefined table includes the objects from the subset, which is communicated by the updating module 445. The redefined table may be generated through exclusion of objects. Excluding the objects from the table may be performed through deleting rows from the table that are associated with the objects allocated to the cluster.

FIG. 4B is a block diagram illustrating a system 452 for determining a plurality of clusters for a set of objects, according to one embodiment. The set of objects may be such as the discussed objects in relation to FIG. 1, FIG. 2, and FIG. 3. Determining the clusters for the set of objects as illustrated on system 452 may be performed, when a defined distance measure satisfies a set of conditions. The set of conditions includes a condition defining that the distance between an object and itself is equal to zero, a symmetric condition for distance computations, and a “triangle inequality” condition. Clustering of the set of objects may be performed according to the methods discussed in relation to FIG. 1, FIG. 2, and FIG. 3. The set of objects is defined in objects definition 410. The clustering is performed according to a clustering criterion 415. The clustering criterion 415 may define a cluster distance threshold value for determining the plurality of clusters. The clustering criterion 415 may be such as the distance threshold value 420, FIG. 4A. The objects definition 410 may correspond to the objects definition 410 from FIG. 4A. An evaluation module 455 receives the objects definition 410 and the clustering criterion 415 to determine a cluster definition 485. Based on computations of distance values, evaluation may be performed to determine clusters with objects. In one example, the evaluations may correspond to the described evaluations in relation to FIG. 4A, and in relation to FIG. 2, and the examples in Table 1, 2, and 3. Based on evaluations of the distance values between objects, a cluster definition 485 is generated. The evaluation module 455 includes a distance computation module 457, a comparing module 465, a clustering module 472, a check module 480, an updating module 475, a selection module 470, an ordering module 460, and a sphere definition module 462.

In one embodiment, the evaluation module 455 may iteratively determine a subset of objects from the set of objects defined in the objects definition 410 to perform evaluation over a smaller number of distances, compared to all of the distances between the objects from the subset. Therefore, the evaluation module 455 optimizes the process of iteratively determining the plurality of clusters for the defined set of objects. The smaller number of distances may be determined for a first iteration for determining a first cluster. Further, a set of distances is defined for computation at a given subsequent iteration. The set of distances may be determined for the subsequent iteration based on determined clusters at previous iterations. The number of distances that are computed during the iterative process of determining clusters may be a smaller number compared to the number of distances between every two object from the set of objects. In such manner, the process of clustering is optimized through minimizing the computing resources for computation and evaluation. When a smaller number of computations are performed, then less computing time and resources may be spent for determining the clusters for the defined set of objects.

The selection module 470 includes implementation logic to select an object from the set of objects that are evaluated at a current iteration of determination of clusters. The selection module 470 may also determine a subset of all of the objects from the set, to be evaluated at a first iteration. The selected object is provided to the ordering module 460 to order the objects in an ordered list according to the distance between the selected object and other objects. Based on the defined selected object by the selection module 470, the distance computation module 457 may be invoked to compute the distances between the selected object and a subset of objects from the objects definition 410. The subset of objects may be defined iteratively during subsequent iterations of the process of determining clusters. The subset of objects may be provided to the distance computation module 457 through the comparing module 465, or the ordering module 460. The selection of an object may be performed from the determined first subset for the first iteration. Subsequent subsets may be determined for subsequent iterations. The subsequent subsets may be defined in a diminishing order of number of objects within the subsets. The evaluated objects are the objects that are associated with the current iteration of clustering. When a subset is determined for evaluation for a particular iteration, then a request for computation of distances between a selected object from the subset and the rest of the objects may be requested from the distance computation module 457.

In a first example, all of the objects may be evaluated at once. In a second example, a subset of objects may be used for a first iteration, and a subsequent subset may be defined for any further subsequent iteration. In the second example, for a first iteration of determining clusters, the ordered list of objects with respect to a first selected object may be communicated with a sphere definition module 462. The sphere definition module 462 may determine a set of spheres that enclose the objects as presented on a coordinate system. In a scenario where the distance measure satisfies the “triangle inequality” condition, the sphere definition module 462 may define a set of nested subsets that may be associated correspondingly with the iterations for determining the plurality of clusters for the set of objects. Based on the defined ordered list of objects communicated by the ordering module 460, the sphere definition module 462 may define the set of nested subset of objects as a set of sphere centered at the selected object. The set of spheres may be defined with radiuses in an increasing order starting from the defined threshold distance value from the clustering criterion and increasing with a step, equal to the threshold distance value.

The defined set of nested subsets may be provided to the comparing module 465 by the sphere definition module 462. The comparing module 465 selects a first pair of subsets, which are the first two spheres, defined around the selected object. The comparing module 465 includes logic to evaluate the distances between objects from these two spheres with the defined threshold distance. In one embodiment, the evaluations may be performed on a subset of distances between the objects from the first two spheres. For example, the evaluated distances may be distances between objects from the first sphere and distances between objects from the first sphere and objects from the second sphere. In the presented example, distances between objects that are part of the second sphere, but are not part of the first sphere, may not be evaluated.

When the first cluster is determined, the process of clustering is performed iteratively over the rest of the objects part of the set of objects, which are not allocated to a cluster. The comparing module 465 communicates with the clustering module 472 to record the definition of the first cluster. The clustering module 472 communicates with a check module 480 to determine whether the set of objects is completely evaluated and whether all of the objects are allocated to clusters. When the check module 480 determines that the set of objects is not completely evaluated, then the check module 480 invokes an updating module 445. The updating module 445 evaluated the set of objects to determine a subset of the set that includes objects that are not allocated to already defined clusters. The updating module 445 communicates with the selection module 470 to suggest a new subset of objects, from which subset a new object will be selected for a new sphere definition, in a similar manner. For example, the updating module 445 may provide a new subset of objects to include those of the objects from the second sphere defined in the current iteration, that were not allocated to a cluster, together with the rest of the objects that are clustered. The updating module 445 may use techniques utilizing a data structure, as a double linked list, to redefine the objects to be included in subsequent subsets of objects, defined iteratively during the process of clustering.

When the check module 480 determines that the set of objects is evaluated completely and all of the objects are allocated to clusters, then the evaluation module 455 communicates the defined clusters. The evaluation module 455 provides a cluster definition 485. Such as definition may be provided in a different manner, through a user interface of an application, in a file format, voice menu, or other alternative solutions.

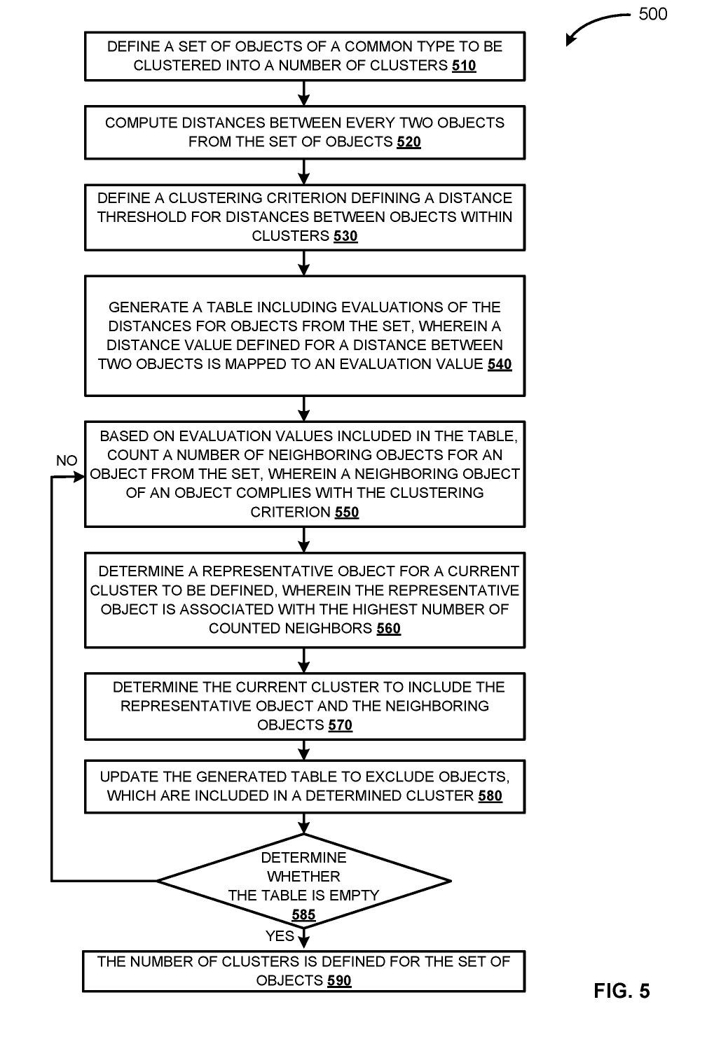

FIG. 5 is a flow diagram illustrating a process 500 for determining a plurality of clusters for a set of objects, according to one embodiment. The set of objects may be corresponding to the discussed objects that are clustered in FIG. 1, FIG. 2, FIG. 3, and FIG. 4. At 510, the set of objects is defined for clustering into a number of clusters. The set of objects are of a certain type. The type may be a common type for all of the objects from the set. The type of objects may be associated with a common structure for describing the objects. The structure may define the properties associated with the type of the objects. At 520, distances between every two objects from the set of objects are computed. The computation of the distances may be according to a predefined formula for computation. The computation may be based on computing distances between property values of the objects, which property values are defined correspondingly to the properties from the structure of the objects. The distances between the objects may be such as the distances computed for the four objects discussed in relation to FIG. 2 and presented in Table 1. At 530, a clustering criterion is defined. The clustering criterion defines a distance threshold for distance between objects within cluster. The distance threshold may define an upper bound for the distance between objects to be grouped in a cluster. All clusters from are associated with this clustering criterion. Therefore, all of the objects grouped in any one of the clusters have distances between each other no larger than the defined distance threshold. At 540, a table is generated that includes evaluations of the distance for objects from the set. The table may be such as Table 2. A distance value defined for a distance between two objects is mapped to an evaluation value according to comparisons between the distance values and the clustering criterion. At 550, based on the evaluation values determined in the generated table, a number of neighboring objects for an object from the set is counted. A neighboring object may be such as the discussed neighbors in relation to FIG. 2 and the generated Table 3. The count of the neighbor objects may be performed as discussed in relation to FIG. 2 and presented in the last column of Table 3. A neighboring object of an object from the set is an object, which complies with the defined clustering criterion. At 560, a representative object for a current cluster is determined. The representative object is the object associated with the highest number of counted neighbors. In reference with the example from FIG. 2 and Table 3, the representative object that is determined was the object associated with point A, because that object was associated with the highest count of neighbors equal to 2. At 570, the current cluster is determined to include the representative objects and the neighboring objects. At 580, the generated table is updated to exclude objects, which are included in a determined cluster. For example, at a first iteration, if a cluster is determined at 570, then all of the objects allocated to that cluster are excluded from the table. Excluding the objects from the table may be performed through deleting the rows from the table that are associated with the objects allocated to the cluster. For the update of the table, techniques utilizing data structures such as “double linked lists” can be used. At 585, it is determined whether the table as updated is empty. If the table is not empty, then there are still objects, which are not allocated to a cluster. Therefore, the process 500 goes to step 550, where the evaluation values in the table (as updated) are used to determine the neighboring objects for the remaining objects in the table. The process 500 continues iteratively through steps 550 to 585, until the table is empty. If at 585 it is determined that the table is empty, then at 590 the number of clusters is defined for the set of objects. The clusters are the determined clusters at all of the iterations performed through following steps 550 to 585.

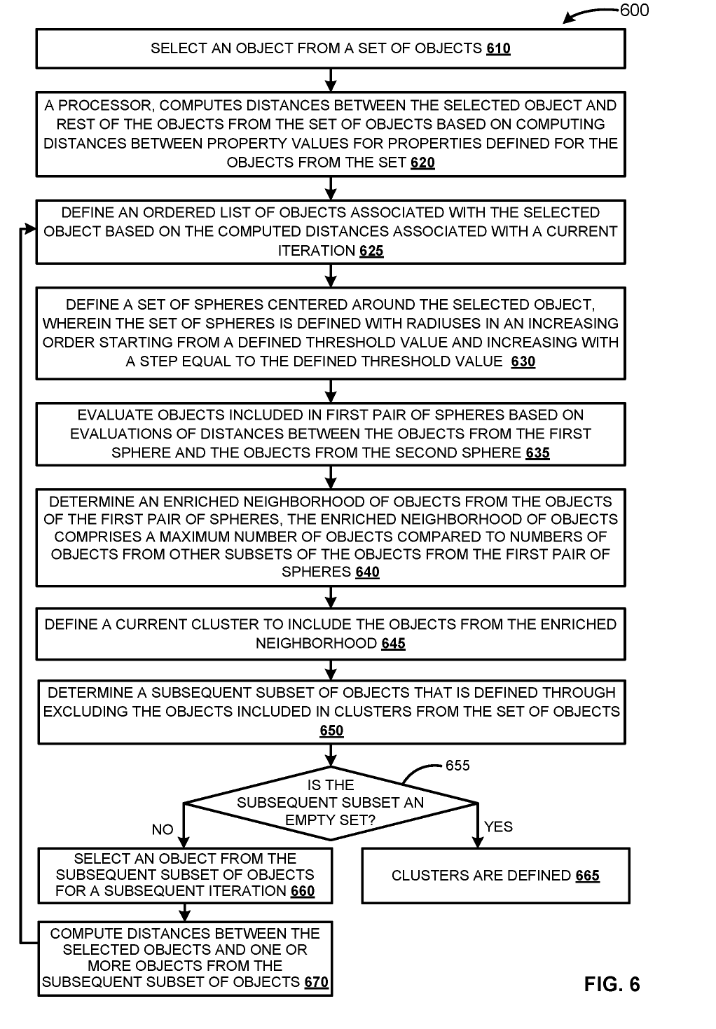

FIG. 6 is a flow diagram illustrating a process 600 for determining a plurality of clusters within a set of objects, according to one embodiment. The process of determining clusters may be an iterative process, where during a number of iterations, different computations and evaluations are performed to optimize usage of computing resources and save time. At 610, an object from the set of objects is selected. Determining the clusters for the set of objects may be performed, when a defined distance measure between the objects satisfies a set of conditions. The set of conditions includes a condition defining that the distance between an object and itself is equal to zero, a symmetric condition for distance computations, and a “triangle inequality” condition. At 620, a processor computes distances between the selected object and rest of objects from the set of objects. The computation of the distances is based on computing distances between property values for properties defined for the objects. At 625, an ordered list of objects is defined. The ordered list is associated with the selected object and is based on ordering the objects according to the computed distances between the object and rest of the objects from the set of objects that are associated with a current iteration. At 630, a set of spheres is defined. The spheres may be centered around projection point of the selected object on a projection area, for example, a coordinate system. The spheres are defined with radiuses in an increasing order starting from a defined threshold value and increasing with a step equal to the defined threshold value. The defined threshold value may be a threshold value defined within a clustering criterion for determining clusters. The threshold value may be denoted as “r”. For a first sphere from the set, a center of the sphere is the selected object and the radius is equal to “r”. The second circle from the set is also with the same center, the point corresponding to the selected object. The radius for the second sphere equals 2*r (two multiplied by “r”). Then a third sphere is also with the same center point and the radius is 3×r (3 multiplied by “r”), and so on for the rest of the spheres that are determined. The number of spheres in the set of spheres may be defined in such a manner as to enclose projection point of all of the objects from the set on the projection area.

At 635, objects included in the first pair of spheres are evaluated based on evaluations of distances between the objects. The evaluations are performed in relation to the defined clustering criterion. The clustering criterion includes the threshold value for the distance between objects within a cluster. The evaluations performed over the objects from the first pair of spheres may correspond to described evaluation of objects at 340, FIG. 3. The evaluations may be evaluations over distances between objects from the first sphere and between objects from the first sphere and the second sphere.

At 640, an enriched neighborhood of objects is determined. The enriched neighborhood is determined from the objects from the first pair of spheres. Subsets including objects that comply with the clustering criteria may be defined within the first pair of spheres. The subsets may be defined to include at least the objects from the first sphere. The number of objects allocated to each of the subsets may be counted. The counted numbers of objects for the subsets may be compared to determine the highest number, and then the subset that is associated with that highest number may be determined to be the enriched neighborhood of objects. The other subsets of objects may also be defined to include objects that comply with the defined clustering criterion. The enriched neighborhood includes the objects from the first sphere and additional objects from a first ring. A ring may be defined as a section of the second sphere, which is not part of the first sphere.

At 645, a current cluster is defined to include the objects from the enriched neighborhood. At 650, a subsequent subset of objects is determined. The subsequent subset is defined through excluding the objects included in clusters from the set of objects. The rest of the plurality of clusters is determined iteratively. The plurality of clusters may be determined iteratively based on evaluations of the distances between objects from the iteratively defined subsets. A subsequent subset of objects may be determined based on one or more defined clusters at one or more preceding iterations. At 655, it is determined whether the subsequent subset of objects is an empty set. If the subsequent subset is empty, then at 665, clusters are defined. If the subsequent subset of objects is not an empty set, then at 660, an object from the subsequent subset is selected for a subsequent iteration.

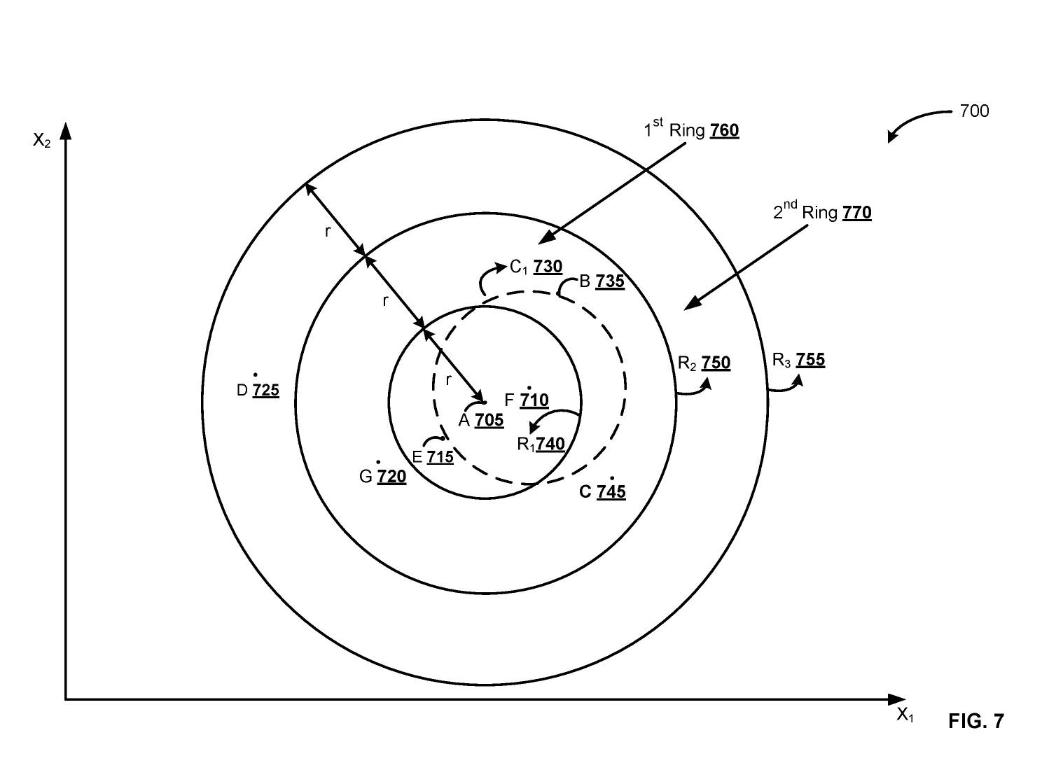

In one embodiment, the selection of an object for a next iteration may be defined in an optimized order to traverse smaller intersections defined between the spheres before larger intersections. For example, area size of intersections of areas between spheres may be used for defining an order for selecting a subsequent object for a subsequent cluster. If for a given iteration, the objects from a pair of spheres are evaluated, then for a subsequent iteration, a selection of an object may be defined from objects from an intersection between the second sphere and the first sphere, which intersection includes object from the second sphere that are not part of the first sphere. Such intersection may be called a ring. Rings may be used iteratively for determining subsequent objects for subsequent iterations for determining clusters. If for example, there are no objects in such a ring, then the selection may be defined from a next larger ring, compared to the previous one. In some embodiment, based on determination of an object for a subsequent iteration according to an order of rings, a new set of spheres may be defined in addition to the defined set of spheres at 630. The new set of spheres may be used to determine a next cluster in a corresponding manner to the process described at 630, 635, 640, etc. If such an approach is utilized, then the order of a subsequent object to be selected for determining a subsequent cluster, may further be optimized, through following an order of selection according to presence of objects in intersections defined between the set of spheres at 630 and the new set of spheres. Further details in relation to the selection of objects for subsequent iterations are discussed in relation to FIG. 7 and an exemplary process for selecting points for determining clusters.

At 670, distances between the selected object from the subsequent subset of objects and other objects from the subsequent subset are computed. The other objects from the subsequent subset corresponding to a subsequent iteration in the process of determining clusters. The other objects, to which distances are computed from the selected object, are objects that are not included into clusters. The iterative process of determining clusters is directed to 625 for defining an ordered list of objects associated with the selected object. A different list of objects is defined for different iterations. The iterative process continues with process steps 630, 635, etc., until the objects from the set are allocated to clusters.

The iterative determination is based on evaluations of distances between objects from subsets of objects from the set of objects. When a current subset of objects is defined for an iterative step, then the cluster determination may be performed as discussed at 625 to 645. The iterative determination is performed over reduced sets of objects, which may be determined for correspondingly to iterations. The reduced number of objects for a current iteration, may be determined based on excluding already included objects in clusters from previous iterations. The iterative determination of the plurality of clusters may be such as the described iterative determination of clusters discussed at FIG. 5. During the iterations, subsequent subsets of objects may be defined for evaluation.

FIG. 7 is a block diagram illustrating an exemplary projection 700 of a set of objects on a coordinate system for determining a plurality of clusters based on circles definitions to optimize the clustering process, according to one embodiment. Determining the clusters for the set of objects as illustrated in the exemplary projection 700 may be performed, when a defined distance measure satisfies a set of conditions. The set of conditions includes a condition defining that the distance between an object and itself is equal to zero, a symmetric condition for distance computations, and a “triangle inequality” condition. The projection 700 is over a two-dimensional coordinate system. The set of objects are projected as points A 705, B 735, C 745. D 725, E 715. F 710, and G 720. Points are clustered based on a defined clustering criterion. The clustering of the set of objects may be performed as suggested in process 600, FIG. 6.

Point A 705 is selected. A set of circles that includes all of the points is determined. The set of circles is with a center point A 705 and radiuses defined in an increasing order starting with a defined clustering distance, for example, the value “r”. To include all of the point, 3 circles are generated—R₁ 740. R₂ 750, and R₃ 755. The point that are part of the first pair of circles, respectfully R₁ 740 and R₂ 750 are point A 705, B 735, F 710, C 745, E 715 and G 720. These points are evaluated to determine an enriched neighborhood of those points for the selected point A 705. The enriched neighborhood includes at least the points from the first circle R₁ 740. The distances between the points from the first circle R₁ 740 and the points from the second circle R₂ 750 are computed and are evaluated in regards to the defined clustering distance as a clustering criterion. For example, distances between objects B 735 and F 710, and objects E 715 and B 735 may be computed. Distances between objects from a first ring 760, defined as an intersection between the second circle R₂ 750 and the first circle R₁ 740, are not computed. The first ring 760 is defined to include objects part of the second circle R₂ 750 but not part of the first circle R₁ 740. For example, distance between point C 745 and point B 735 is not computed. The evaluation of the objects includes evaluation of the distances between the objects through comparing the distances with the clustering distance criterion. The evaluation may correspond to the discussed evaluations of objects and distances in relation to the example discussed at FIG. 2, and the suggested evaluations of distances in Table 2.

In one embodiment, in the current exemplary projection point A 705, point F 710 and point E 715 may be grouped in a first subset of objects from the objects part of the first two circles. These 3 points comply with the clustering criteria defining a distance threshold value “r”. However, such a subset may not be the subset with the maximum number of objects (maximum cardinality). For example, point A 705, point E 715, point F 710, and point B 735 may be grouped in a second subset, which complies with the clustering criterion. The second subset includes 4 elements. Other subsets of points that may be determined to comply with the clustering criterion include less than 3 elements. Therefore, the subset, which includes the highest number of elements (maximum cardinality), is the second subset. The second subset may be defined as the enriched neighborhood. Point F 710 may be a representative element for such an enriched neighborhood. The first cluster to be determined for all of the objects may correspond to that enriched neighborhood, which includes 4 objects corresponding to point A 705, point E 715, point F 710, and point B 735. The first cluster may be denoted by C₁ 730 and may be represented as a circle on the exemplary projection 700. The cluster C₁ 730 is with a radius equal to “r” and includes point A 705, point E 715, point F 710, and point B 735. Points A 705, E 715, F 710 and B 735 are excluded for further evaluation to determine other clusters for the set of objects.

The rest of the objects that are evaluated to determine further clusters are objects projected at points G 720, D 725, and C 745. A point from these three points may be selected and evaluations to determine a second cluster may be performed. Such evaluations for determining a second cluster may correspond to the evaluations performed for the first circle. If all of the three points may not be grouped in one cluster, then those of the points that are not included in a second cluster, may be evaluated to determine a third cluster, and so forth. This evaluation may be an iterative process. The iterative process may end when all of the points from the initial set of objects are allocated to clusters. The clustering ends with a definition of a number of clusters, where a cluster includes one or more objects. Objects from a cluster comply with the defined clustering criterion. In some embodiment, there may be more than one option to arrange objects into clusters.

In one embodiment, a selection of a point for a subsequent iteration may be defined from a set of points, which are not included in previous iterations into clusters. The selection may be performed according to an optimized order to traverse area intersections between the defined circles according to the size of the area intersections. For example, for the exemplary projection 700, a set of rings may be defined as intersections between the circles. A first ring 760 and a second ring 770 are determined. The first ring 760 is with a smaller area size compared to the second ring 770. For example, for a second iteration for the exemplary projection 700, a point may be selected from the first ring 760. In the first ring 760, point G 720 and C 745 are from the first ring 760. One of these points may be selected for a second iteration of determining clusters.

For example, an order of selecting points to iteratively determine clusters may be defined according to an algorithm comprising steps, which may be incorporated in the process suggested in FIG. 6 and the example from FIG. 7. The plurality of objects for clustering may be ordered with respect to a first selected object. An object “O” may be determined from the ordered list, which has a maximum distance to the first selected object. The object “O” may be used for the definition of rings, which are determined as intersections between spheres defined around object “O”. The determined nested spheres with center—the selected object o, are defined with radiuses equal to r, 2r, 3r and so on (“r” is defined as a distance threshold value for clustering) until every object is contained in a sphere. A cluster may be determined by calculating an enriched neighborhood from the first pair of spheres for the object “O”. The objects that are included in the determined cluster are removed from the first pair of spheres. Then, a next iteration of the iterative process may be defined to determine clusters, through determining rings as suggested in an algorithm presented in Table 4.

TABLE 4
1) Determine a set of rings, where a ring is associated with a “i”-th number, where “i”-th
ring (1 ≦ i) contains all objects of the “i + 1”-th circle without the elements of the “i”-th
circle
2) Iterate over every nonempty rings “i” in an increasing order:
2.1) Select an object o′ from the current “i”-th ring,
2.2) Order the list of objects contained in the “i”-th, “i + 1”-th and “i + 2”-th rings with
respect to o′, and
2.3) Determine a set of nested circles with a center o′ and with radiuses r, 2r, 3r, etc,
where r is the distance threshold value defined for the clustering. The set of nested circles
are determined until every object of the ordered list is included in a circle
2.4) Iteratively determine clusters by determining enriched neighborhoods of objects from
the objects of the first pair of circles, the iterative determination of clusters including:
2.4.1) Define a subset of objects associated with the subsequent iteration, where the
subset is determined by removing objects allocated to determined cluster in previous
iterations from the first pair of the circles defined in the current iteration and from the i-
th, (i + 1)-th and (i + 2)-th rings defined in step 1)
2.4.2) Determine a new set of rings, where “j”-th ring (1 ≦ j) includes all elements of the
“j + 1”-th circle defined in sub-step 2.4.1 without the elements of the “j”-th circle defined
in step 2.1)
2.4.3) For every nonempty ring “j” defined in sub-step 2.4.2) in increasing order:
2.4.3.1) Define for every m and n, where i ≦ m ≦ i + 2 and j − 2 ≦ n ≦ j + 2 a set Mm, n to be the
intersection of the m-th ring defined in step 1) with n-th ring defined in step 2.4.2)
2.4.3.2) While M i, j it is not an empty set, then:
2.4.3.2.1) Select an object o″ from the set M i, j,
2.4.3.2.2) Order the objects from the set M i, j with the respect to the selected object o″
2.4.3.2.3) Determine a new set of nested circles with a center the selected object o″ and
with radiuses r, 2r, 3r, etc. until every object of M i, j is contained in a circle
2.4.3.2.4) Determine a cluster by determining an enriched neighborhood from the first
pair of circles defined in sub-step 2.1)
2.4.3.2.5) Remove the objects of the cluster from the sets and M i, j from the “i”-th, “i + 1”-
th, “i + 2”-th rings defined in step 1) and from the “j − 2”-th, “j − 1”-th, “j”-th, “j + 1”-th, and
“j + 2”-th rings defined in step 2.4.2)

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and read-only memory (ROM) and random access memory (RAM) devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

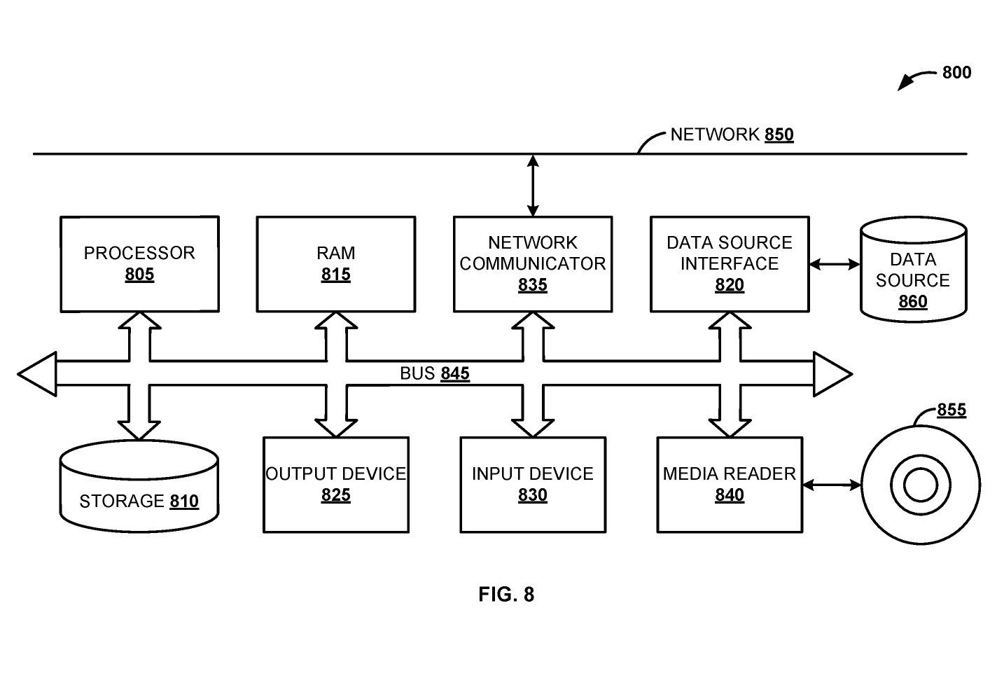

FIG. 8 is a block diagram of an exemplary computer system 800. The computer system 800 includes a processor 805 that executes software instructions or code stored on a computer readable storage medium 855 to perform the above-illustrated methods. The processor 805 can include a plurality of cores. The computer system 800 includes a media reader 840 to read the instructions from the computer readable storage medium 855 and store the instructions in storage 810 or in RAM 815. The storage 810 provides a large space for keeping static data where at least some instructions could be stored for later execution. According to some embodiments, such as some in-memory computing system embodiments, the RAM 815 can have sufficient storage capacity to store much of the data required for processing in the RAM 815 instead of in the storage 810. In some embodiments, all of the data required for processing may be stored in the RAM 815. The stored instructions may be further compiled to generate other representations of the instructions and dynamically stored in the RAM 815. The processor 805 reads instructions from the RAM 815 and performs actions as instructed. According to one embodiment, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system. XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope of the one or more embodiments, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to determine clusters in a plurality of objects, the method comprising:
defining a clustering criterion for determining a cluster;
a processor, computing property distances between values for properties of the objects from a set of the plurality of objects;
a processor, computing object distance between a first object and a second object from the set of objects based on the property distances; and
when the first object is a part of the cluster, adding the second object to the cluster when the object distance complies with the clustering criterion.

2. The method of claim 1, further comprising:
the processor, iteratively determining the clusters based on a plurality of iterations for evaluations of distances between objects from the plurality of objects according to the clustering criterion, wherein a subsequent subset of objects from the plurality of objects is evalated at a subsequent iteration,
wherein the clusters are non-intersecting sets of objects from the plurality of objects.

3. The method of claim 2, further comprising:
determining the set of objects to be clustered;
wherein objects from the set of objects am defined according to a structure corresponding to a type of the objects from the set, wherein the structure defines the properties associated with the type of the objects.

4. The method of claim 2, wherein the cluster from the clusters is associated with a representative object from the set of objects.

5. The method of claim 4, wherein the clustering criterion is associated with a definition for measuring the object distance between two objects from the set of objects, and wherein a cluster comprises one or more objects from the set of objects complying with the clustering criterion, the clustering criterion defining a threshold value for the distance between the representative object for the cluster and other objects within the cluster.

6. The method of claim 5, wherein iteratively determining the clusters based on the plurality of iterations for evaluations of the distances between the objects from the plurality of objects according to the clustering criterion further comprises:
the processor, determining a first cluster comprising a maximum number of objects from the set of objects that comply with the defined clustering criterion, wherein the first cluster is determined through evaluating the distances between objects from the set of objects; and
the processor, iteratively determining rest of the clusters based on evaluations of distances between objects from subsets of objects from the plurality of objects, wherein the subsequent subset of objects is determined based on one or more defined clusters at one or more preceding iterations.

7. The method of claim 6, wherein during a first iteration from the iterative determination of the clusters the first cluster is determined, wherein the first iteration is associated with the set of objects for evaluation, and wherein a subsequent subset of objects associated with a subsequent iteration is defined based on excluding objects from the plurality of objects, and wherein the excluded objects are objects which are included in one or more iteratively defined clusters during one or more preceding iterations.

8. The method of claim 6, wherein determining the first cluster further comprises:
defining an ordered list of objects associated with the first object based on computing distances between the first object and rest of objects from the plurality of objects;
defining a set of spheres centered around the first object, wherein the set of spheres are defined with radiuses in an increasing order starting from the defined threshold value and increasing with a step equal to the defined threshold value;
evaluating objects included in a first pair of spheres based on evaluations of distances between the objects, wherein the evaluated distances are defined between objects included in a first sphere and objects included in a subsequent sphere, where the first and the subsequent sphere are nested spheres;
determining an enriched neighborhood of objects from the objects of the first pair of spheres that includes objects complying with the defined clustering criterion, and wherein the enriched neighborhood of objects comprises the maximum number of objects compared to other subsets of the objects from the first pair of spheres, other subsets complying with the defined clustering criterion; and
defining the first cluster to include the objects from the enriched neighborhood.

9. A computer system to determine clusters in a set of objects, comprising:
a processor;
a memory in association with the processor storing instructions related to:
define a clustering criterion for determining a cluster, wherein the clusters are non-intersecting sets of objects from the set of objects, wherein the clustering criterion is associated with a definition to measure a distance between two objects from the set of objects, and wherein the clustering criterion defining a threshold value for the distance between objects within the cluster;
compute property distances between values for properties of the objects from the set;
compute object distance between a first object and a second object from the set of objects based on the property distances; and
when the first object is a part of the cluster, add the second object to the cluster when the object distance complies with the clustering criterion.

10. The system of claim 9, wherein the memory further stores instructions related to:
iteratively determine the clusters based on a plurality of iterations for evaluations of distances between objects from the plurality of objects according to the clustering criterion, wherein a subsequent subset of objects from the plurality of objects is evalated at a subsequent iteration,
wherein a cluster from the clusters is associated with a representative object from the set of objects.

11. The system of claim 9, wherein the memory further stores instructions to:
determine the set of objects to be clustered;
wherein objects from the set of objects are defined according to a structure corresponding to a type of the objects from the set, wherein the structure defines the properties associated with the type of the objects.

12. The system of claim 9, wherein the instructions related to iteratively determining the clusters based on the plurality of iterations for evaluations of the distances between the objects from the plurality of objects according to the clustering criterion further comprise instructions to:
determine a first cluster comprising a maximum number of objects from the set of objects that comply with the defined clustering criterion, wherein the first cluster is determined through evaluating the distances between objects from the set of objects; and
the processor, iteratively determine rest of the clusters based on evaluations of distances between objects from subsets of objects from the plurality of objects, wherein the subsequent subset of objects is determined based on one or more defined clusters at one or more preceding iterations.

13. The system of claim 12, wherein during a first iteration from the iterative determination of the clusters the first cluster is determined, wherein the first iteration is associated with the set of objects for evaluation, and wherein a subsequent subset of objects associated with a subsequent iteration is defined based on excluding objects from the plurality of objects, and wherein the excluded objects are objects which are included in one or more iteratively defined clusters during one or more preceding iterations.

14. The system of claim 12, wherein the instructions related to determining the first cluster further comprise instructions related to:
defining an ordered list of objects associated with the first object based on computing distances between the first object and rest of objects from the plurality of objects;
defining a set of spheres centered around the first object, wherein the set of spheres are defined with radiuses in an increasing order starting from the defined threshold value and increasing with a step equal to the defined threshold value;
evaluating objects included in a first pair of spheres based on evaluations of distances between the objects, wherein the evaluated distances are defined between objects included in a first sphere and objects included in a subsequent sphere, where the first and the subsequent sphere are nested spheres;
determining an enriched neighborhood of objects from the objects of the first pair of spheres that includes objects complying with the defined clustering criterion, and wherein the enriched neighborhood of objects comprises the maximum number of objects compared to other subsets of the objects from the first pair of spheres, other subsets complying with the defined clustering criterion; and
defining the first cluster to include the objects from the enriched neighborhood.

15. A non-transitory computer-readable medium storing instructions, which when executed cause a computer system to perform operations comprising:
defining a clustering criterion for determining a cluster, wherein the clusters are non-intersecting sets of objects from the set of objects, wherein the clustering criterion is associated with a definition to measure a distance between two objects from the set of objects, and wherein the clustering criterion defining a threshold value for the distance between objects within the cluster;
computing property distances between values for properties of the objects from the set;
computing object distance between a first object and a second object from the set of objects based on the property distances; and
when the first object is a part of the cluster, adding the second object to the cluster when the object distance complies with the clustering criterion.

16. The computer-readable medium of claim 15, further comprising instructions to:
iteratively determine the clusters based on a plurality of iterations for evaluations of distances between objects from the plurality of objects according to the clustering criterion, wherein a subsequent subset of objects from the plurality of objects is evalated at a subsequent iteration,
wherein a cluster from the clusters is associated with a representative object from the set of objects.

17. The computer-readable medium of claim 15, further comprising instructions to:
determine the set of objects to be clustered;
wherein objects from the set of objects are defined according to a structure corresponding to a type of the objects from the set, wherein the structure defines the properties associated with the type of the objects.

18. The computer-readable medium of claim 15, wherein the instructions related to iteratively determining the clusters based on the plurality of iterations for evaluations of the distances between the objects from the plurality of objects according to the clustering criterion further comprise instructions related to:
determining a first cluster comprising a maximum number of objects from the set of objects that comply with the defined clustering criterion, wherein the first cluster is determined through evaluating the distances between objects from the set of objects; and
the processor, iteratively determining rest of the clusters based on evaluations of distances between objects from subsets of objects from the plurality of objects, wherein the subsequent subset of objects is determined based on one or more defined clusters at one or more preceding iterations.

19. The computer-readable medium of claim 18, wherein during a first iteration from the iterative determination of the clusters the first cluster is determined, wherein the first iteration is associated with the set of objects for evaluation, and wherein a subsequent subset of objects associated with a subsequent iteration is defined based on excluding objects from the plurality of objects, and wherein the excluded objects are objects which are included in one or more iteratively defined clusters during one or more preceding iterations.

20. The computer-readable medium of claim 17, wherein the instructions related to determining the first cluster further comprise instructions related to:
defining an ordered list of objects associated with the first object based on computing distances between the first object and rest of objects from the plurality of objects;
defining a set of spheres centered around the first object, wherein the set of spheres are defined with radiuses in an increasing order starting from the defined threshold value and increasing with a step equal to the defined threshold value;
evaluating objects included in a first pair of spheres based on evaluations of distances between the objects, wherein the evaluated distances are defined between objects included in a first sphere and objects included in a subsequent sphere, where the first and the subsequent sphere are nested spheres;
determining an enriched neighborhood of objects from the objects of the first pair of spheres that includes objects complying with the defined clustering criterion, and wherein the enriched neighborhood of objects comprises the maximum number of objects compared to other subsets of the objects from the first pair of spheres, other subsets complying with the defined clustering criterion; and
defining the first cluster to include the objects from the enriched neighborhood.
